(19) United States
(12) Patent Application Publication
(10) Pub. No.: US 2017/0169492 A1
(43) Pub. Date: Jun. 15, 2017

(54) Method and Structure for 3D Model Creation, Analysis, and Product Fit

(71) Applicants: Silvio Reggiardo, III, Cameron Park, CA (US); Christopher V Reggiardo, Castro Valley, CA (US); Mark William Reggiardo, Castro Valley, CA (US); Silvio Patrick Reggiardo, Cameron Park, CA (US); David Russell Reggiardo, Castro Valley, CA (US)

(72) Inventors: Silvio Reggiardo, III, Cameron Park, CA (US); Christopher V Reggiardo, Castro Valley, CA (US); Mark William Reggiardo, Castro Valley, CA (US); Silvio Patrick Reggiardo, Cameron Park, CA (US); David Russell Reggiardo, Castro Valley, CA (US)

(21) Appl. No.: 14/968,904

(22) Filed: Dec. 15, 2015

(51) Int. Cl. G06Q 30/06; G06F 17/30; G05B 19/4099

(52) U.S. Cl. CPC G06Q 30/0621; G05B 19/4099; G06F 17/30522; G05B 2219/35134; B33Y 10/00

(57) ABSTRACT

A 3D model creation and comparison method and structure allowing consumers to more efficiently purchase standard and semi-custom and to create custom products.

### CROSS-REFERENCE TO RELATED APPLICATIONS

Provisional Application U.S. 62/124,313; Priority Date 15 Dec. 2014; Reggiardo, Silvio III and Reggiardo, Christopher V.; 3D Model Comparison for Product Fit

### STATEMENT REGARDING FEDERALLY SPONSORED RESEARCH OR DEVELOPMENT

Not Applicable

### REFERENCE TO SEQUENCE LISTING, A TABLE, OR A COMPUTER PROGRAM LISTING COMPACT DISK APPENDIX Not Applicable

### REFERENCES CITED

### U.S. Patent Documents

| | | |
|---|---|---|
| 6,741,728 | May 2004 | Genest |
| 7,830,374 | November 2010 | Chang |
| 8,753,119 | June 1041 | Fang |

### BACKGROUND OF THE INVENTION

The present invention relates to three-dimensional (3D) model creation and analysis to more efficiently allow consumers to purchase standard, semi-custom, and custom products.

Consumers often want to purchase standard-size (as opposed to semi-custom and custom-made) items but can have a difficult time finding the proper fit. This is common with ready-to-wear apparel footwear, such as shoes and boots, that have a limited number of size options (e.g., the length and width of a shoe). It can be a problem for in-person (such as in-store) purchases, and even more of a problem for purchases over the Internet or by mail because Consumers cannot be sure how the items will fit until after receiving the shipment. This problem is exacerbated with size and fit variations between manufacturers and with respect to the type of product such as dress shoes or boots. 3D models can be created by the consumer using readily available consumer electronics such as a laptop, tablet, or smartphone with a camera and an internet connection. Consumers do not have to search out and go to the location of commercial 3D scanners. The information can be compared with 3D models from seller information, resulting in a process of providing consumers with better fitting products, which will save consumer time while reducing vendor costs associated with stocking extra product and processing returns. The information from consumer purchases and returns can be used to empirically improve the product selection process. Similarly, the 3D model information can be used to create semi-custom products such as shoes for those with particular needs and even custom-products using the same technologies developed for the standard and semi-custom products.

### SUMMARY OF THE INVENTION

The present invention is a method of creating and comparing consumer 3D model information obtained from consumer electronic devices to more efficiently purchase standard, semi-custom, and custom products.

The 3D model information created by the consumer can be compared with 3D product model information from sellers to find products that best fit the consumer 3D model information and thus better fit consumers. As a result, consumers will purchase the best fitting products more efficiently than with a trial and error approach. This will reduce the volume of product returns, saving sellers and consumer time and money. The consumer 3D model information can come from pictures of objects (such as consumers' feet) that are converted to 3D models (a deterministic approach), they can come from empirical consumer purchase information, or they can come from a combination of these approaches. Product sellers (such as manufacturers or retailers) would provide 3D information regarding products. A computer would compare the consumer and seller 3D information, providing the best match and indicating how likely a consumer will be satisfied with a particular fit. For semi-custom products, the seller information can include the aspects of the product that can be customized to provide the best fit. The technology developed can also be used to create custom models

### BRIEF DESCRIPTION OF THE DRAWINGS

The drawings illustrate features and functionality of the invention that is best understood from the detailed description of the invention in conjunction with the drawings.

FIG. 1 is a diagram illustrating a method and structure for creating and comparing standard and semi-custom products.

FIG. 2 is a diagram illustrating the creation of semi-custom or custom parts using a 3D printer.

FIG. 3 is a drawing of the bottom of a typical left foot and illustrates some of the features of the foot used in creating a 3D model for purchasing standard or semi-custom footwear.

The drawings are not to scale and are representations intended to depict typical embodiments of the invention and, therefore, should not be considered as limiting the scope of the invention.

### DETAILED DESCRIPTION OF THE INVENTION

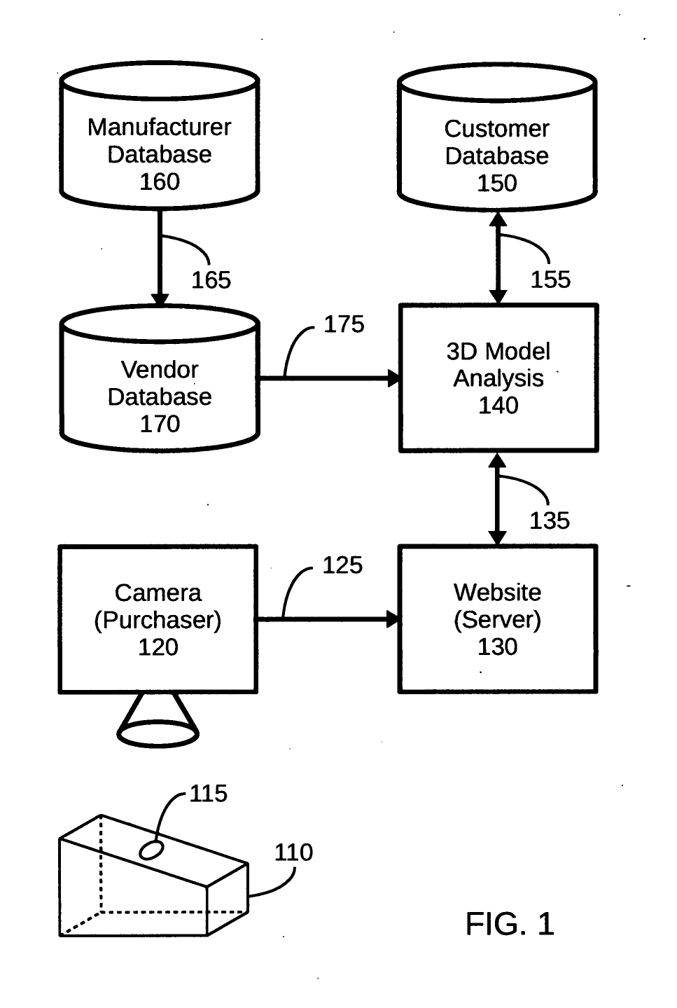

The first aspect of the invention for creating and comparing standard and semi-custom products is illustrated in FIG. 1 for an object 110 which may relate to any standard or semi-custom product. For example, 110 may be a foot and the standard or semi-custom product is a type of footwear such as a shoe or boot. A reference item 115 is optionally placed on the object 110 to provide size information for the imaging device 120 which is typically a camera belonging to the consumer. The reference item 115 may not be needed if the imaging device is a 3D camera with imaging abilities sufficient to provide an appropriate 3D model; however, the reference item 115 may be used even with a 3D camera to provide more accurate size information or when the 3D imaging abilities of the imaging device are not know by the consumer.

The reference item 115 may be anything with known dimensions, such as the diameter of a coin used as common currency for the region in which object 110 is being imaged (e.g., a penny, nickel, dime or quarter commonly used as US currency). A flat circular object, such as a coin or washer has the advantage that if it is resting on a surface that is not perpendicular to the imaging device 120, the dimension along the axis of tilt, the long edge of the oval, is always the true diameter of the reference item 115. The minimum dimension of the oval can then be used as added information to obtain the tile of the surface for the object 110 where the reference item 115 is placed. Although a flat circular object has the advantages stated above, it can be appreciated that any size, shape, or material can be used for the reference item 115 provided the dimensions are known (e.g., a 3″×5″ card or a small coin-cell battery). If the reference item 115 does not have sufficient contrast with the object 110, then a piece of material, such as colored paper or cloth, may be placed behind the reference item 115 to provide contrast without significantly affecting the ability to detect contours and edges within the boundary of the object 110. Similarly, if object 110 is of similar color to the background, contrast material may be used behind object 110 to highlight the outline (outer edges) of object 110 or different lighting may be employed (e.g., a photo flash).

The imaging device 120 may a commercially available camera including, but not limited to, those integrated into common consumer electronics such as cellphones, smartphones, tablets, laptops, and computers and the like. If the imaging device 120 is a type of camera, it may be a traditional single image camera, a 3D camera, a traditional camera outfitted with a 3D imaging device, or other varieties and combinations consumer electronics capable of taking photographic images. The imaging device 120 may also be a laser scanner or any other device that captures an image of an object, such that the pictures collectively capture an image of the 3D object being measured, and therefore the imaging device 120 could be moved manually or automatically to take pictures at positions necessary to create a 3D model.

The images from imaging device 120 may be processed by a program (i.e., an application) on the imaging device 120 or on the website (server) 130. The program guides the consumer in taking the appropriate number of images (photos) with the specified orientation (e.g., top, front, right side) as needed to construct a 3D model for the given imaging technology. In one embodiment the program runs on website server 130 and the unprocessed images are sent from the imaging device 120 via the communications means 125 to the website (server) 130 for processing. In another embodiment the program runs on the imaging device 120 and the 3D model is sent from the imaging device 120 via the communications means 125 to the website (server) 130. In yet another embodiment a program runs on both the imaging device 120 and the website (server) 130 and some of the processing is done by each program with intermediate results sent from the imaging device 120 via the communications means 125 to the website (server) 130. The communications means 125 may be any form or combination of electronic communication means including, but not limited to, a wired connection such as ethernet or a cable modem, WiFi, Bluetooth, Cellular and the like.

The 3D model is communicated to a 3D Model Analysis program 140 via communications means 135 which in turn communicates the 3D model to a Customer Database 150 via communications means 155. Once the 3D model is saved in the Customer Database 150 it is available for use in guiding the consumer in selecting product. It can be appreciated that once the initial 3D model is saved to the Customer Database 150 it may be updated whenever a consumer deems it appropriate. For the example of footwear, occasions that would benefit from an updated 3D model include, but are not limited to, growth, weight gain or loss, pregnancy, which can often affect shoe size, foot surgery, illness and the like. The 3D model can even account for seasonal foot swelling such as when the feet are slightly larger in the summer.

Once a 3D model is established and stored in Customer Database 150 the 3D Model Analysis program uses that information as one means of determining product fit. It can be appreciated that if no 3D model is available, then the Website (Sever) 130 can request and obtain information from the consumer that is useful in making an initial purchase. Again, for the footwear example the size and width of the consumers shoe preference may be used as a starting point.

A manufacturer communicates 3D model information from a Manufacturer Database 160 to the Vendor Database 170 via communications means 165. In turn the Vendor Database 170 communicates information via communications means 175 to the 3D Model Analysis program 140. In some cases, the manufacturer is the vendor and the Vendor Database 170 is the same as (matches) the Manufacturer Database 160. Indeed, some or all of the various databases may be combined and for a manufacturer that is the vendor the Website (Server) 130, 3D Model Analysis 140, the Customer Database 150, the Manufacturer Database 160, the Vendor Database 170, and all communications means may be on the same computer (server). In other embodiments some or all of these elements are combined or run on the same computers (servers).

When a consumer uses the website (server) 130 to purchase product, the request for the type of product desired is communicated to the 3D Model Analysis program 140 which obtains information from the Customer Database 150, if available, and Vendor Database to inform the purchasing decision. Once the consumer has made a purchase, the 3D Model Analysis program 140 communicates the results back to the Customer Database 150 for future reference including, but not limited to fit and style preferences. It can be appreciated that while the deterministic and empirical 3D information can be combined, these 3D information gathering techniques could also be used in isolation.

Once the consumer receives the product and decides what product to keep and what product to return, the results are also saved to the Customer Database 150 for future reference including, but not limited to fit and style preferences as indicated by the consumer. The composite of the 3D model (deterministic) and consumer preferences (empirical) are used in subsequent purchases to guide the consumer in selecting product. One result of this process is a higher confidence that the product provided to the consumer will not be returned and less vendor stock is required to cover product in transit that may be returned. Another result includes satisfied consumers who are more likely to continue to do business with the vendor.

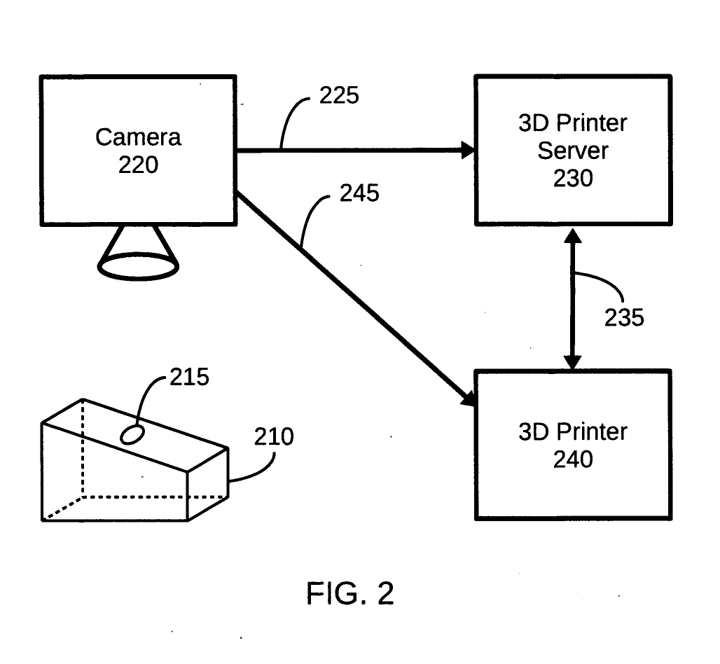

The second aspect of the invention for creating semi-custom and custom products is illustrated in FIG. 2 for an object 210 which may relate to any semi-custom or custom product. For example, 210 may be a damaged or worn part and the semi-custom or custom product is a type of part for an antique automobile which is no longer available for purchase (e.g., a taillight lens). Another example is a part that if modified would function better and the 3D model of the image can be modified as appropriate (e.g., using the program that drives the 3D printer) to improve functionality. As described above with respect to FIG. 1, the details of creating a 3D model are similar and only the key points are repeated for clarity. The types of parts that may be 3D printed are based on the technology of the 3D printer; however, many different materials can be 3D printed including a variety of forms of plastic and metal. A 3D part can even be printed in an easy to modify material (e.g., plastic) and adjusted for fit or preference, then an adjusted 3D model can be used to print the final part in a more durable material (e.g., metal).

Object 210 is imaged with an optional reference item 215 as needed to provide size information for the imaging device 220 which is of similar type and functionality as imaging device 120. Some or all of the 3D image processing may occur on the imaging device 220 with images or results, partial or complete, communicated to the 3D Printer Server 230 via communications means 225. It can be appreciated that the 3D Printer Server 230 can contain a library of semi-custom part parameters or request information from a website (server) which is not shown in FIG. 2 but functions in a similar fashion to that described in FIG. 1 for the website (server) 130 and the Vendor Database 170. It can also be appreciated that the part from the library or website can be modified for improved fit or functionality before being printed.

The 3D Printer Server 230 then prepares the appropriate commands and data for the 3D printer 240 and communicates those commands and data via communications means 235 to create the semi-custom or custom part. Alternatively, the 3D printer may have integrated control functionality and not need a 3D Printer Server 230 such that the appropriate commands and data may be communicated directly from the imaging device 220 via communications means 245.

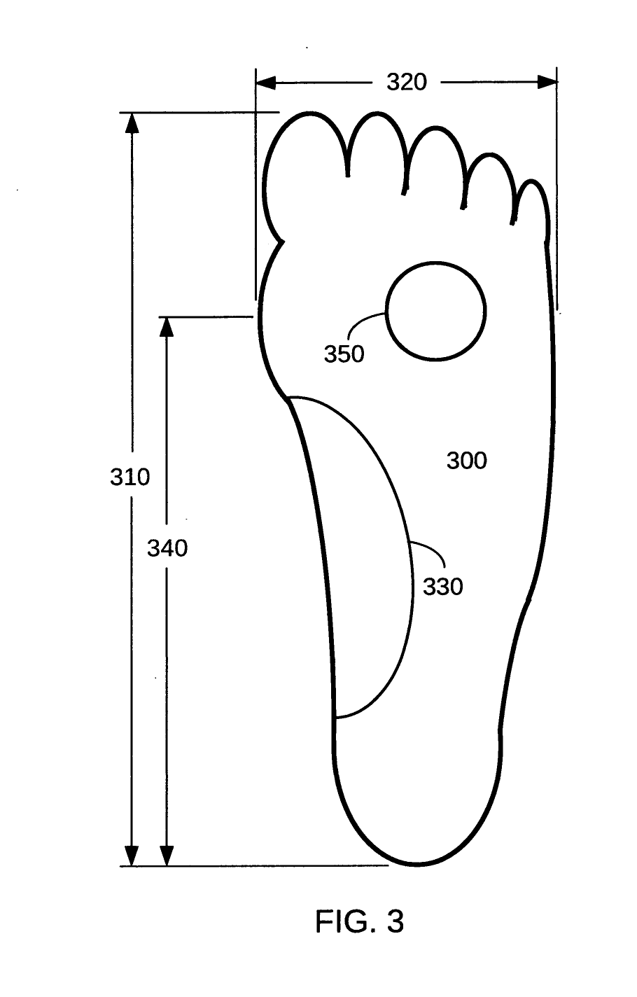

Returning to the example of footwear, FIG. 3 shows the bottom of a typical left foot 300 as appropriate for ordering standard (i.e., off-the-shelf) or semi-custom footwear. The primary measurement for footwear is the length 310 and the secondary measurement is the width 320. The shape of the arch 330 is often categorized in broad terms as low, medium, or high for common insoles with only custom or semi-custom orthotics having more resolution than the three typical values. The type of insole or orthotic is a consideration for the type of footwear as some cause the foot to take more volume in the shoe or boot when used and can affect the fit of the footwear. Although the distance from the heel to the arch 340 can affect the fit of footwear, it is often ignored or used to indicate a larger shoe or boot be selected than indicated solely by the length 310. Similarly, if the width does not feel correct, the solution is often to select a larger size (length) of footwear as many shoes and boots do not come in a width other than medium. For completeness, a reference item 350 is shown to indicate the size of the foot.

The length 310 of the foot 300 is typically the only measure of footwear available to the consumer which leads to high return rates for purchases over the Internet or by mail. Some footwear is offered in narrow or wide options to account for the width 320 of the foot and can guide the consumer in a better fit. The shape of the bottom of the foot as shown in FIG. 3 can better guide the consumer into selections which are likely to fit well, but this option is often only available for semi-custom or custom footwear. A 3D model of the foot 300 would best guide the consumer in selecting proper fitting footwear.

A 3D model of a typical foot can be obtained from two or more images of the foot with the bottom of the foot, as shown in FIG. 3, being the primary image. Indeed, just the image of the bottom of the foot contains enough information that it could provide a significant improvement in product fit as compared to just the length and width. For the case described above of starting with no 3D model, an improvement is to start with just the 2D model of the bottom of the foot.

The secondary image for creating a 3D model of a typical foot is the side of the foot (e.g., showing the inside ankle) where the volume of the foot and size of the ankle can be determined. It can be appreciated that the scale of the image can be determined from a reference item or 3D camera, or by correlating the length of the foot with the length of the foot 310 as determined from the image of the bottom of the foot as shown in FIG. 3. Additional images would provide a better 3D model with the primary and secondary images providing the essential deterministic model that will be improved with empirical fit data over time.

Consumers who want to purchase standard products in person, over the Internet, or by mail typically use a trial and error approach. Even if consumers have similar products from the same manufacturer, the fit might not be the same due to product or consumer physical changes over time or due to seasonal foot swelling. The present invention would provide a process for allowing product consumers (consumers) and sellers to match their 3D information in a manner would make purchasing faster and would reduce the likelihood of ill-fitting products (which would in turn reduce product returns and related costs for sellers and consumers alike).

The consumer might be interested not just in having proper shoe length and width, but also its arch height and its general form (commonly referred to as a shoe's last). The consumer could ask for information regarding all shoes of any make and style within the data pool, or the consumer could narrow the search by asking for information regarding only particular shoe brands. The consumer could even limit the search to particular styles of footwear, such as sneakers, boots, loafers or Oxfords. Based on a computer comparison of 3D data (e.g., minimizing differences between 3D models to focus on the best match), the computer could inform the consumer that a particular shoe maker makes a certain line of shoes in the size and last that best fits the consumer's feet. It is worth noting that the consumer could even purchase a different shoe size for each foot since manufacturers create each shoe (left and right) separately. This may be the due to many factors including when the two feet are not be the same size or when one foot has had an injury or undergone surgery.

A similar approach could be used for a consumer who, for example, wants to purchase a shirt, glove, hat or a helmet. This purchasing approach would not be limited to shoes or apparel or even to products for humans. For example, a consumer could use this approach to purchase a saddle for a horse, or a replacement bannister knob. The consumer would provide a 3D model of the particular object in the manner described above and the computer would compare product data information, informing the consumer of the best match. This approach could be used for in-person (e.g., in-store), Internet, mail purchases and the like. This method can also be used to distinguish between similar parts (e.g., parts for antique automobiles or older appliances) where the standard is to order the “best guess” and see if it fits. In such a case, the 3D model can be used to refine the options and increase the probability of obtaining the correct part.

When the consumer allows information regarding actual purchases to be gathered, sellers are able to improve the 3D models of the purchased products. They are then able to provide the same type of consumer feedback and product recommendations as described above. For example, if a consumer purchases three sneakers over the Internet and returns one pair, the computer would determine the 3D information for the products the consumer kept. The relevant information for future consumer purchase decisions can further be informed with user feedback related to the reason for the return (e.g., style, tight in the toe-box, too narrow). This actual purchase information could be used alone or with various aspects of the 3D model. Or, consumers could simply use the 3D information and not use (or release) empirical purchase information.

While one aspect of this invention initially compares standard seller product information and consumer object information, and focuses on allowing consumers to find the best standard product fit, some sellers could modify and thus customize standard products in response to consumer object information. A database of 3D information for different consumer groups can be compared with the products they will likely purchase (based on 3D model information) and the seller's products can be modified or designed to best fit Consumers. This provides an advantage to traditional sellers that want to stock products most likely to sell. This also provides a strategic advantage as new products are developed to reflect changing popular styles and trends based on the most likely consumer fit parameters.

The concept of using 3D imaging of consumer information (such as dimensions of a foot) and comparing it with a database of 3D imaging vendor information (such as shoe last dimensions) is not novel or unique. U.S. Pat. No. 6,741,728 B1, for example, covers this process as applied to shoe lasts. However, the present invention describes a practical method of using consumer electronics (such as the currently ubiquitous cell phone camera, and the new 3D cell phone technology that will likely become ubiquitous), rather than less common or available commercial 3D scanners, to capture consumer 3D information. Consumers can easily gather and send 3D measurement information from their homes or other convenient locations.

Additionally, this invention does not limit the 3D information to use in a static manner for either the consumer or the manufacturer and vendors based on the 3D image. Instead, it allows the consumer model to adapt to consumer preferences and allows manufactures and vendors not only to adjust their product mixes and designs based on 3D consumer information, but it also allows them to adjust subsequent product recommendations based on empirical information from post-purchase consumer behavior (such as returns due to improper fit or such as subsequent purchases of particular products that fit well).

In broad embodiment, the present invention is a system of creating a 3D model with common consumer electronic devices and comparing purchaser and seller product 3D models by computer to provide consumers with the best fitting standard and semi-custom products more efficiently than trial and error fitting. The technology described is also appropriate for purchasing semi-custom and custom products and parts and for creating some of those parts using a 3D printer as appropriate. Although one of ordinary skill is enabled to make and use what is currently considered to be the best mode thereof, the above written description of the invention enables those of ordinary skill to understand and appreciate the existence of variations, combinations, and equivalents of the specific embodiment, method, and examples herein. Therefore, the invention should not be limited by the above described embodiment, method, and examples, but by all embodiments and methods within the scope and spirit of the invention as claimed.

What is claimed is:

1. An imaging method comprising a commercially available electronic device having photographic capability and a means of determining the size of the object imaged.

2. claim 1 where the photographic capability is a three dimensional (3D) camera with sufficient imaging capability to determine the size of the object imaged.

3. claim 2 where a reference item of known size is used to improve the imaging capability to more accurately determine the size of the object imaged.

4. claim 1 where the photographic capability is a traditional camera with sufficient imaging capability to determine the size of the object imaged when used with a reference item of known size to determine the size of the object imaged.

5. claim 1 where a plurality of images are used to construct a 3D model.

6. claim 5 where the 3D model may be used to select a part from a source of available standard and semi-custom parts that best replaces the object imaged.

7. claim 6 where the selected part may be adjusted for better fit or functionality.

8. claim 7 where the part may be printed on a 3D printer.

9. claim 5 where the 3D model may be adjusted for better fit or functionality.

10. claim 9 where the part may be printed on a 3D printer.

11. claim 5 where the 3D model may be saved to a database as a source of information to improve consumer product fit through empirical means.

12. A data management method consisting essentially of a consumer fit and preference database and a means to empirically improve consumer product selection.

13. claim 12 where consumer purchases and returns are used to update the consumer fit and preference database and empirically improve consumer product selection.

14. claim 12 where consumer feedback is used to update the consumer fit and preference database and empirically improve consumer product selection.

15. claim 12 where seasonal information is used to update the consumer fit and preference database and empirically improve consumer product selection.

16. A data management method consisting essentially of a user fit and preference database and a means to improve the manufactured products available to the consumer.

17. claim 16 where consumer purchases and returns are used to update the consumer fit and preference database and empirically improve the manufactured products available to the consumer.

18. claim 16 where consumer feedback is used to update the consumer fit and preference database and empirically improve the manufactured products available to the consumer.
